(19) United States
(12) Patent Application Publication
(10) Pub. No.: US 2014/0122334 A1
(43) Pub. Date: May 1, 2014

(54) Payment Processing with a User Identifier

(71) Applicant: BANK OF AMERICA CORPORATION, Charlotte, NC (US)

(72) Inventors: Jennifer M. Lucas, Charlotte, NC (US); Matthew R. Leavenworth, Charlotte, NC (US); James G. Ronca, Decatur, GA (US); Jason P. Blackhurst, Charlotte, NC (US)

(73) Assignee: Bank of America Corporation, Charlotte, NC (US)

(21) Appl. No.: 13/663,824

(22) Filed: Oct. 30, 2012

(51) Int. Cl. G06Q 20/40

(52) U.S. Cl. 705/44

(57) ABSTRACT

According to an embodiment, a payment is processed. It is determined that a user should receive a payment. A user identifier associated with the user is received. The user identifier allows the user to receive communications. The user identifier does not comprise information regarding any financial account of the user. Whether the user identifier is registered with an account server operable to maintain associations between user identifers and financial accounts is determined. The user is requested to register the user identifier with the account server if the user identifier is not registered with the account server. Transfer of the payment is facilitated by a selected one of a transfer to a financial account associated with the user identifier and issuance of the payment by an alternative mechanism according to whether the user identifier is registered with the account server.

### TECHNICAL FIELD OF THE INVENTION

This invention relates, in general, to payment processing and, more particularly, to payment processing with a user identifier.

### BACKGROUND OF THE INVENTION

Enterprises provide many goods and services for purchase by individuals at retail locations. Additionally, these enterprises may need to provide a payment to individuals themselves for various purposes. Enterprises may have several options for providing payments to individuals. At times, the available options for completing payment transactions may be unavailable, unreliable, and/or inconvenient.

### SUMMARY OF THE INVENTION

In accordance with the present invention, disadvantages and problems associated with processing payments may be reduced or eliminated.

According to one embodiment of the present invention, a payment is processed. It is determined that a user should receive a payment. A user identifier associated with the user is received. The user identifier allows the user to receive communications. The user identifier does not comprise information regarding any financial account of the user. Whether the user identifier is registered with an account server operable to maintain associations between user identifiers and financial accounts is determined. The user is requested to register the user identifier with the account server if the user identifier is not registered with the account server. Transfer of the payment is facilitated by a selected one of a transfer to—a financial account associated with the user identifier and issuance of the payment by an alternative mechanism according to whether the user identifier is registered with the account server.

Certain embodiments of the invention may provide one or more technical advantages. A technical advantage of one embodiment allows an entity to provide a payment to a user without requiring the user to provide any private information, such as a financial account number. Another technical advantage of an embodiment allows an entity to issue an electronic payment to a user instead of providing a paper check in the amount of the payment. Another technical advantage of an embodiment allows an entity to keep track of all of its payment transfer requests through reporting of aggregate metrics. Notifications may be sent to the entity and/or the user providing status updates during the payment transfer process and when the transfer is completed. In particular embodiments, the notifications sent to the user may include message content pre-defined by the entity. The notifications may appear to be sent from the entity when they are actually sent from another source.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates an example system operable to process a payment to a user.

FIG. 2 illustrates an example flow chart for processing a payment to a user.

### DETAILED DESCRIPTION OF THE INVENTION

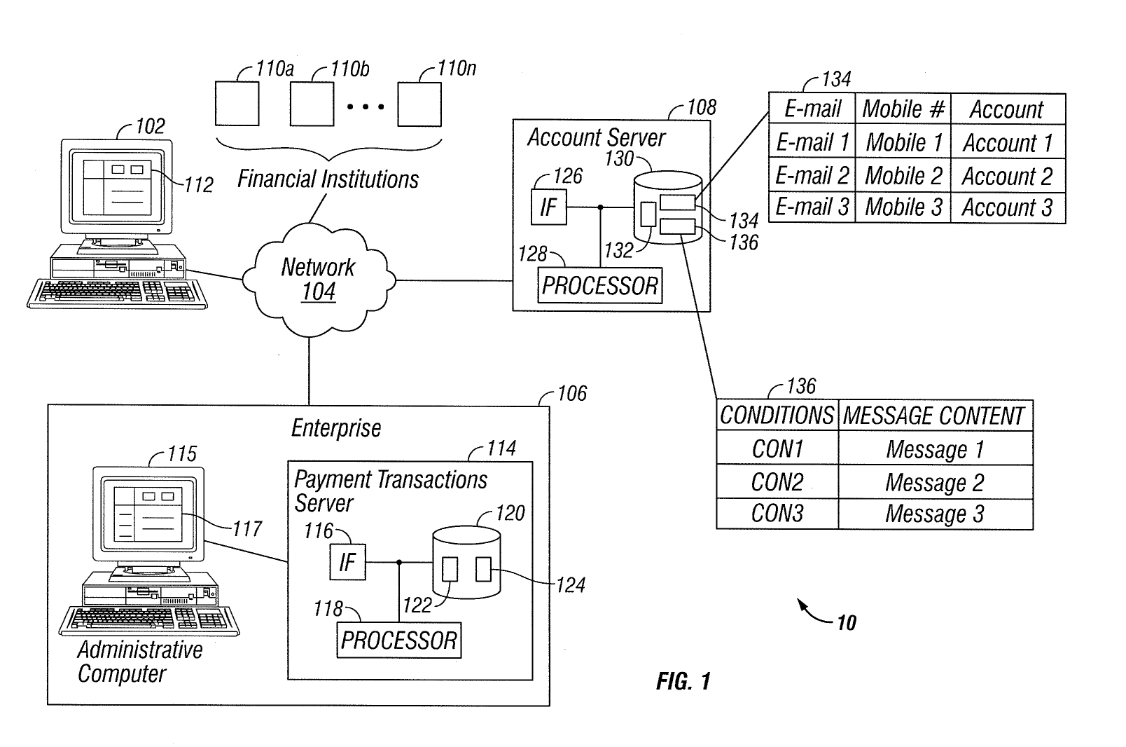

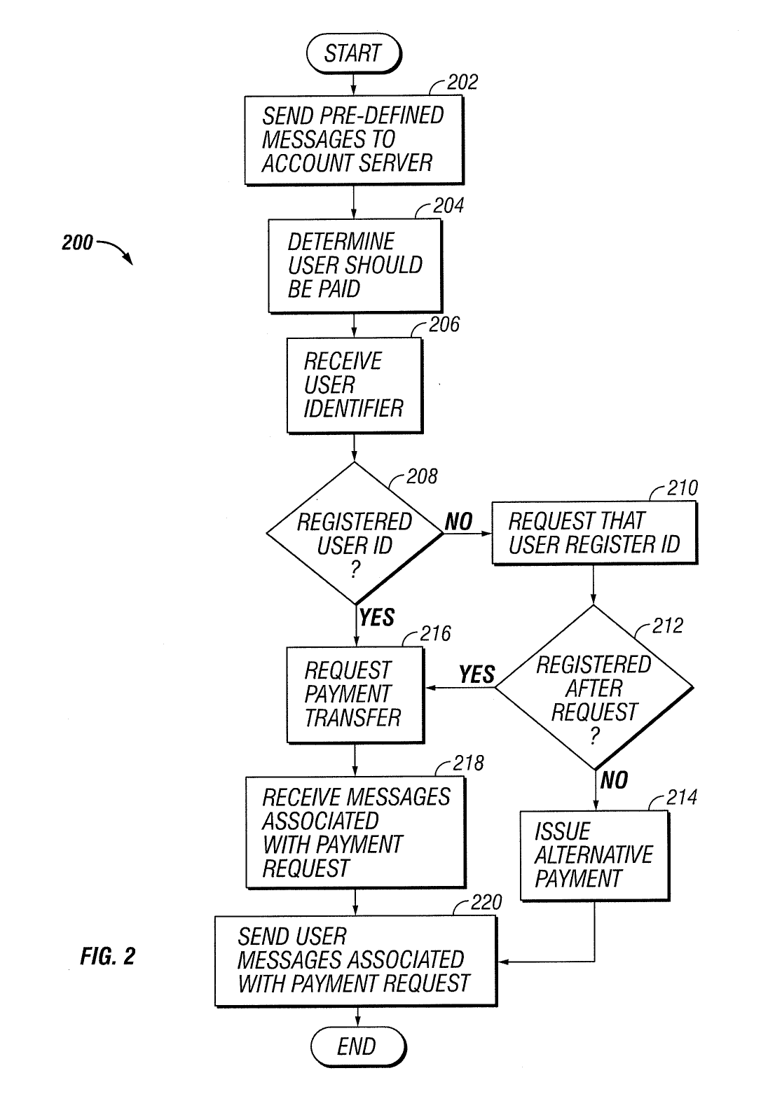

Embodiments of the present invention and its advantages are best understood by referring to FIGS. 1 through 2, like numerals being used for like and corresponding parts of the various drawings.

FIG. 1 illustrates a system 10 operable to facilitate payment processing to a user. Certain embodiments of system 10 include a device 102 operated by a user and an enterprise 106. System 10 may allow device 102 to receive a payment from enterprise 106 by presenting a non-confidential user identifier, such as an e-mail address or a phone number. For example, enterprise 106 may want to issue a refund and/or a rebate to a user. In particular embodiments, enterprise 106 may be able to issue the payment to an account held at a financial institution 110 of the user without receiving any information regarding the particular financial institution that administers the user's account, the user's account number, and/or any other information regarding the specific user account. An account server 108 maintains associations between user identifiers and accounts associated with the user. Where appropriate, devices 102, enterprise 106, account server 108, and financial institutions 110 communicate with one another over network 104.

Devices 102 are operable to allow a user to communicate with the other components of system 10. For example, a user may communicate a user identifier associated with the user to enterprise 106 for processing of a payment transaction. Devices 102 may include any suitable software to carry out its functions. For example, devices 102 may run any suitable operating system such as WINDOWS, MAC-OS, UNIX, LINUX, iOS, Windows Mobile, Android, and/or any other suitable operating system. Devices 102 may also include any suitable native applications, such as a web browser application, a messaging application, and/or a natively-installed client application specifically configured to work with one or more components of enterprise 106, account server 108, and/or financial institutions 110.

In certain embodiments, devices 102 include a graphical user interface (“GUI”) 112, which displays information sent to and/or received from the other components of system 10. GUI 112 is generally operable to tailor and filter data entered by, and presented to the user. GUI 112 may provide the user with an efficient and user-friendly presentation of information. For example, GUI 112 may display information associated with a user account and provide options for actions associated with the account. As another example, GUI 112 may provide the user of the device with options to register an account with account server 108. GUI 112 may comprise a plurality of displays having interactive fields, pull-down lists, and buttons operated by the user. GUI 112 may include multiple levels of abstraction including groupings and boundaries. It should be understood that the term GUI may be used in the singular or in the plural to describe one or more GUIs and each of the displays of a particular GUI 112.

GUI 112 may be displayed to a user using a web browser that allows a user of access devices 102 to interact with a website, communicatively coupled to enterprise 106, financial institution 110, and/or account server 108. For example, a user of device 102 may use GUI 102 to manage a user account administered by a financial institution 110, engage in on-line commerce with enterprise 106, and/or manage registrations with account server 108. Suitable web browsers may include Microsoft Internet Explorer®, Mozilla Firefox®, Google Chrome™, Apple Safari™, or Opera®. In certain embodiments, GUI 112 may be displayed using an application natively installed on each device 102. For example, a financial institution 110 may create and distribute an account management application designed for a mobile phone embodiment of device 102 and another account management application designed for a tablet computer embodiment of device 102 that both operate outside of a web browser. A user may install the account management application on an access device and interact with the GUI provided by the account management application to communicate with financial institution 110, enterprise 106, and/or account server 108.

In certain embodiments, a user uses device 102 to send a user identifier to enterprise 106 and/or account server 108. The user identifier, in particular embodiments, does not relate directly with any financial institution 110. Additionally, the user identifier may comprise information that is less sensitive than identifiers specifically associated with a financial account. In certain embodiments, the user identifier is sufficient to allow communication requests to reach the user. Such user identifiers may include an e-mail address, phone number, instant messaging user name, and/or a social media identifier. One advantage of using identifiers of these types is that they may be unique to one user as opposed to a given name, which may be shared by many users. If an entity, such as enterprise 106, attempts to issue a payment to the user through the user identifier and the user identifier is not registered with account server 108, then the user may be contacted through the user identifier to set up registration, as described in more detail below. In some embodiments, registration with account server 108 will not be successful. In such embodiments, the user may use device 102 to provide another identifier directly associated with a financial account administered by financial institution 110, such as the name of the financial institution, a financial account number, and/or any other suitable information directly associated with a financial account.

Network 104 represents any suitable network that facilitates communication between the components of system 10. Network 104 may include any interconnecting system capable of transmitting audio, video, signals, data, messages, or any combination of the preceding. Network 104 may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, any other suitable communication link, including combinations thereof operable to facilitate communication between the components of system 10.

Financial institutions 110 may refer to any organization that administers financial accounts including banks, credit unions, savings and loan associations, investment companies, stock brokerages, asset management firms, and/or any other suitable financial institution. The accounts administered by financial institutions may include a checking account, a savings account, a brokerage account, a loan account, an investment account, a retirement account, an education savings account, and/or any other suitable account. Financial institutions 110 include any suitable components necessary to transfer funds from the account of one entity to the account of another entity. The accounts of the different entities may be administered by different financial institutions 110. In such cases, financial institutions 110 may use a general transfer network to carry out the funds transfer from the account of a first entity to an account of a second entity. The general transfer network may use any suitable portion of network 104. In some embodiments, a funds transfer may be between two accounts administered by the same financial institution 110. These types of transfers may be completed in less than time than transfers that must be processed through a separate transfer network.

Enterprise 106 refers to any entity that makes a payment to a user. For example, enterprise 106 may be a commercial and/or financial entity that purchases older goods from the user for refurbishment and/or resell, issues a refund for returned goods, issues a rebate for purchased goods, disburses a balance of an account following an account closure, and/or any other suitable payment type. Enterprise 106 may be a government organization that sends a user a tax refund and/or periodic payments for government grants and/or assistance. Enterprise 106 may also be an insurance agency that pays the user the value of an insurance claim. Certain embodiments of enterprise 106 include a payment transactions server 114 and an administrative computer 115.

Payment transactions server 114 includes any suitable combination of components that facilitate issuance of a payment to a user. Payment transactions server 114 may have the ability to issue payment through multiple mechanisms. For example, payment transactions server 114 may be able to initiate payment to a user using a user identifier that is not directly related to a financial account. Payment transactions server 114 may communicate with account server 108 in real-time to determine whether the payment can be made using the user-identifier. If payment through the user identifier is unsuccessful, then payment transactions server 114 may attempt to issue a payment through another mechanism. For example, enterprise 106 may execute a paper check to send to the user. As another example, enterprise 106 may collect a financial account identifier associated with a financial account of the user at a financial institution 110. Payment transactions server 114 may then initiate the payment to the user's account directly.

In embodiments using the user identifier to process payment through account server 108, payment transactions server 114 may receive additional communications from account status server 108 associated with payment requests. Such communication may comprise updates regarding the status of a payment request, including a confirmation notification indicating that a payment to a user has been completed. Payment transactions server 114 may send payment requests for many different users. Some communications from account server 108 may comprise information reporting and/or aggregating the requests for multiple users. In particular embodiments, payment transactions server 114 may aggregate reports sent from account status server 108 for display on GUI 117 of administrative computer 115.

Payment transactions server 114 may include a network server, any suitable remote server, a mainframe, a host computer, a workstation, a web server, a personal computer, a file, server, or any other suitable device operable to facilitate issuance of a payment to a user. In some embodiments, payment transactions server 114 may execute any suitable operating system such as IBM's zSeries/Operating system (z/OS), MS-DOS, PC-DOS, MAC-OS, WINDOWS, UNIX, OPenVMS, Linux, or any other appropriate operating systems, including operating systems developed in the future. The functions of payment transactions server 114 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

In certain embodiments, payment transactions server 114 includes a network interface 116, a processor 118, and a memory 120.

Network interface 116 represents any suitable device operable to receive information from network 104, perform suitable processing of the information, communicate to other devices, or any combination of the preceding. For example, network interface 116 may receive a user identifier communicated from device 102. Network interface 116 represents any port or connection, real or virtual, including any suitable hardware and/or software, including protocol conversion and data processing capabilities, to communicate through a LAN, WAN, or other communication systems that allows payment transactions server 114 to exchange information with the other components of system 10 and/or any other suitable device.

Processor 118 communicatively couples to network interface 116 and memory 120. Processor 118 controls the operation and administration of payment transactions server 114 by processing information received from network interface 116 and memory 120. Processor 118 includes any hardware and/or software that operates to control and process information. For example, processor 118 executes management software 122 to control the operation of payment transactions server 114. Processor 118 may be a programmable logic device, a microcontroller, a microprocessor, any suitable processing device, or any suitable combination of the preceding.

Memory 120 stores, either permanently or temporarily, data, operational software, or other information used by processor 118. Memory 120 includes any one or a combination of volatile or nonvolatile local or remote devices suitable for storing information. For example, memory 120 may include random access memory (RAM), read only memory (ROM), magnetic storage devices, optical storage devices, or any other suitable information storage device or a combination of these devices. While illustrated as including particular modules, memory 120 may include any suitable information for use in the operation of payment transactions server 114.

In certain embodiments, memory 120 includes management software 122 and management data 124.

Management software 122 represents any suitable set of instructions, logic, or code embodied in a non-transitory, computer readable medium and operable to facilitate the operation of payment transactions server 114. For example, management software 122 may include rules sufficient to allow payment transactions server 114 to communicate with account server 108 in real-time to determine whether a user identifier is registered with account server 108. Management software 122 may also include rules for specifying alternative mechanisms for payment as discussed above. Management software 122 may also enable payment transactions server 114 to facilitate registration of the user with account server 108. For example, management software 122 may specify that payment transactions server 114 should communicate a message to the user requesting that the user register with account server 108. The message may be delivered via the user identifier and/or through a website displayed on GUI 112 of device 102. As another example, payment transactions server 114 may request that account server 108 send a message to the user via the user identifier to request registration of the user identifier. Management software 122 may also send the request to transfer payment once the user identifier is registered with account server 108. In particular embodiments, the request may also include information associated with a source account from which the payment amount should be deducted.

Management software 122 may be configured to specify that payment transactions server 114 communicate with account server 108 in any suitable manner. For example, a specific application programming interface (API) may be developed for communication with account server 108. This API may have specific functions to have the account server perform certain tasks. These tasks may include determining whether a user identifier is registered, making a payment transfer, reporting on payment transfer requests for one or more user identifiers, and/or any other suitable tasks.

Management software 122 may reference information stored in management data 124. Management data 124 may include, for example, a data structure that stores a schedule for multiple payments to a user. For example, management data 124 may specify that a user should receive payments once, monthly, yearly, and/or according to any other timetable. The payment amounts may be equal or different, where appropriate. Payment schedule details may also be received from administrative computer 115.

Management data 124 may also include a data structure that stores an indication of whether a certain user identifier is registered with account server 108. For example, payment transactions server 114 may have previously communicated with account server 108 in connection with a previous payment transfer to determine whether a particular user identifier was registered with account server 108. The determination that the user identifier was registered with account server 108 may be stored in management data 124 together with an expiration time. If it is determined that another payment must be made to the same user associated with the same user identifier before the expiration time, then payment transactions server 114, in some embodiments, may not communicate with account server 108 to determine whether the user identifier is registered. Rather, payment transactions server 114 may submit the payment transfer request immediately.

Management data 124 may also store certain message content that should be delivered to a user associated with a user identifier upon satisfaction of certain conditions. For example, management data 124 may specify that a user should receive certain information when a request for a payment transfer is received by account server 108, when payment processing has begun, when payment processing has completed, and/or at any other suitable time. The message content may include information and/or advertising related to certain services provided by enterprise 106, information related to other enterprises, and/or any other suitable information. These messages may be delivered directly by payment transactions server 114 to the user via the user identifier. In alternative embodiments, payment transactions server 114 may provide these predetermined messages and associated triggering conditions to account server 108 before submitting a payment transfer request or with a payment transfer request to a particular user. Account server 108 may then include these messages in communications to the user via the user identifier when the triggering conditions occur. The communications to the user may also include additional content not determined by enterprise 106, such as content defined by an administrator of account server 108. In some embodiments, account server 108 may configure the communication to the user such that it appears to the user that the communication came directly from enterprise 106.

Administrative computer 115 represents any suitable components operable to configure payment transactions server 114 and/or access data provided by payment transactions server 114. As another example, an administrator may use administrative computer 115 to set up a payment for a user. In such embodiments, a user may provide the administrator with the user identifier over the phone or in-person. For example, the administrator may be a claims examiner that has decided to issue a payment for an insurance claim. The claims examiner may be able to attempt processing of a payment initially using a user identifier not directly associated with the user (e.g., a claim beneficiary). If, for some reason, the registration fails, payment transactions server 114 may automatically fall back to an alternative payment mechanism such as printing a paper check. Because of the real-time communication between payment transactions server 114 and account server 108, all or a significant portion of the transaction may happen while the claims examiner is on the phone with the claim beneficiary and/or while the claim beneficiary is in the physical presence of the claims examiner.

Administrative computer 115 may have other uses as well. An administrator may use administrative computer 115 to update the rules in management data 124 that determine the schedule for a particular payment or set of payments. An administrator may also use administrative computer to view the status of payment transfer requests, failed attempts to process payment using user identifiers and/or alternative payment mechanisms, history of completed payment transfers, and/or any other suitable information. This information may be viewed on GUI 117, which may be similar in operation to GUI 112.

Administrative computer 115 may comprise a network server, any suitable remote server, a mainframe, a host computer, a workstation, a web server, a personal computer, a file, server, or any other suitable device operable to configure the components and rules used by payment transactions server 114. In some embodiments, administrative computer 115 may execute any suitable operating system such as IBM's z/OS, MS-DOS, PC-DOS, MAC-OS, WINDOWS, UNIX, OPenVMS, Linux, or any other appropriate operating systems, including operating systems developed in the future. The functions of administrative computer 115 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

Account server 108 represents any set of one or more components operable to facilitate transactions based on a user identifier. Account server 108 may maintain associations between user identifiers and financial accounts. Account server 108 may receive requests to process payments from an enterprise 106 to a user associated with a particular user identifier. If account server 108 does not include an association between a particular user identifier and a financial account, account server may send a message to the user via the user identifier to request registration of the user identifier. Account server may also send various notifications regarding a payment request to enterprise 106 and/or the user associated with the user identifier.

Account server 108 may include a network server, any suitable remote server, a mainframe, a host computer, a workstation, a web server, a personal computer, a file, server, or any other suitable device operable to facilitate transactions based on a user identifier. In some embodiments, account server 108 may execute any suitable operating system such as IBM's zSeries/Operating system (z/OS), MS-DOS, PC-DOS, MAC-OS, WINDOWS, UNIX, OPenVMS, Linux, or any other appropriate operating systems, including operating systems developed in the future. The functions of account server 108 may be performed by any suitable combination of one or more servers or other components at one or more locations. In the embodiment where the modules are servers, the servers may be public or private servers, and each server may be a virtual or physical server. The server may include one or more servers at the same or at locations remote from one another.

In certain embodiments, account server 108 includes a network interface 126, a processor 128, and a memory 130.

Network interface 126 represents any suitable device operable to communicate with device 102, enterprise 106, and/or financial institutions 110. For example, network interface 126 may communicate with device 102 via a user identifier to set up an association between the user identifier and a financial account. As another example, network interface 126 may communicate with financial institutions 110 to facilitate a payment transfer from enterprise 106 to a user associated with a particular user identifier. Network interface 126 represents any port or connection, real or virtual, including any suitable hardware and/or software, including protocol conversion and data processing capabilities, to communicate through a LAN, WAN, or other communication systems that allows account server 108 to exchange information with the other components of system 10.

Processor 128 communicatively couples to network interface 126 and memory 130. Processor 128 controls the operation and administration of account server 108 by processing information received from network interface 126 and memory 130. Processor 128 includes any hardware and/or software that operates to control and process information. For example, processor 128 executes payment transfer software 132 to control the operation of account server 108. Processor 128 may be a programmable logic device, a microcontroller, a microprocessor, any suitable processing device, or any suitable combination of the preceding.

Memory 130 stores, either permanently or temporarily, data, operational software, or other information for processor 128. Memory 130 includes any one or a combination of volatile or nonvolatile local or remote devices suitable for storing information. For example, memory 130 may include RAM, ROM, magnetic storage devices, optical storage devices, or any other suitable information storage device or a combination of these devices. While illustrated as including particular modules, memory 130 may include any suitable information for use in the operation of account server 108.

In certain embodiments, memory 130 includes payment transfer software 132, user identifier table 134, and messaging table 136.

User identifier table 134 is a data structure operable to maintain associations between user identifiers and financial accounts. In particular embodiments, user identifier table 134 has a table structure where each row may be associated with a particular user. Each row may contain any number of suitable user identifiers associated with a user, such as an e-mail address and/or a mobile phone number.

Each row also has a particular financial account associated with a user. The account information may be the name/identifier of a financial institution 110, an account number associated with an account administered by a particular financial institution 110, and/or any other information suitable to identify a user account administered by a financial institution 110. For example, an e-mail address “Email 1” is associated with financial account “Account 1.” In particular embodiments, each row of user identifier table 134 stores multiple user identifiers associated with a user. In some embodiments, however, user identifier table 134 may not include each type of user identifier for every user. For example, in user identifier table 134, financial account “Account 2” is associated with both e-mail address “E-mail 2” and mobile phone number “Mobile 2.” In alternative embodiments, however, a user may have only registered e-mail address “E-mail 2” and not mobile phone number “Mobile 2.” In that case, mobile phone number “Mobile 2” may not be stored in user identifier table 134.

Messaging table 136 is a data structure operable to store message content that may be delivered to users when certain triggering conditions have been satisfied. The particular messages and the conditions that trigger them may be communicated from payment transactions server 114. These messages may have a general template which is common for messages delivered to all users. As such, the messages may have been communicated from payment transactions server 114 prior to the determination that a payment should be made to a particular user. In certain embodiments, the messages may be specific to the situation of a particular user. In such cases, payment transactions server 114 may communicate certain triggering conditions with and/or after submitting a payment transfer request to account server 136. Thus, messaging table 136 may be specific to a particular user.

The triggering conditions may be any suitable condition. For example, “CON1” may be the condition that a payment transfer request has been received. The associated message content “Message 1” may be, for example, “A request to transfer funds to your registered account from <ENTERPRISE> in the amount of $<PAYMENT AMOUNT> has been received.” The message may contain any other suitable content, such as services provided by enterprise 106. The message may also have branding and/or color schemes associated with enterprise 106. Other conditions may include payment processing has commenced, payment processing is on hold, payment processing has completed, payment transfer succeeded, payment transfer failed, and/or any other suitable condition.

Memory 130 may contain multiple messaging tables 136. A particular messaging table 136 may be associated with a particular user. As another example, a particular messaging table 136 may be associated with a particular enterprise, such as enterprise 106, while another messaging table 136 may be associated with other enterprises. Thus, each enterprise may have customized messaging delivered on its behalf by account server 108 when certain triggering conditions have occurred.

Payment transfer software 132 represents any suitable set of instructions, logic, or code embodied in a non-transitory, computer readable medium and operable to facilitate the operation of account server 108. For example, payment transfer software 132 may include rules sufficient to allow account server 108 to communicate with payment transactions server 114 in real-time in order to inform enterprise 106 that particular user identifier is registered. Payment transfer software 132 may specify that a message request be delivered to a user via a particular user identifier in order to register the user identifier. For example, payment transfer software may specify that an e-mail be sent to an e-mail user identifier requesting registration of the e-mail address. As another example, payment transfer software may specify that a short messaging service (SMS) text message be sent to a mobile phone number user identifier.

During registration, account server 108 may provide the user with a list of participating financial institutions. The list may include some or all of financial institutions 110. The user may provide a suitable financial account number of an account administered by the financial institution. The user may provide any other verifying information required by the particular financial institution to ensure that the user should be associated with this particular financial account. These options may be entered by the user via GUI 112 on device 102. The information may be sent to the particular financial institution to complete the verification process. Once verification has been completed, payment transfer software 132 may specify that an association be stored in user identifier table 134.

When enterprise 106 submits a payment request to a user with a registered user identifier, payment transfer software 132 communicates with the financial institution 110 that administers an account associated with enterprise 106. The payment amount is deducted from the account. The payment amount is then credited to the financial account of the user associated with user identifier. Payment transfer software 132 may specify that notifications should be provided to the user as indicated above. Payment transfer software 132 may also specify that notifications and/or other reporting should be provided to enterprise 106 as well. Such notifications may comprise the result of an attempted payment transfer, such as whether the payment attempt succeeded or failed. Failures may occur, for example, if the user identifier is no longer registered with account server 108 and/or if enterprise 106 has insufficient funds in an account to satisfy transfer of the payment amount.

In an exemplary embodiment of operation of system 10, a user using device 102 attempts to obtain a rebate from enterprise 106, which sells consumer goods, through a website associated with enterprise 106. The website indicates that the rebate may be issued electronically if the user provides a suitable e-mail address. The user may not have to provide other information such as the name of a financial institution and/or a financial account number. In an embodiment, the user provides an e-mail address. Payment transactions server 114 sends a query to account server 108 with the user's e-mail address to determine whether that user's e-mail address is registered. Account server 108 accesses user identifier table 134, determines that the e-mail address has been registered, and sends a notification to payment transactions server 114 indicating that the e-mail address has been registered. Payment transactions server 114 communicates credit instructions to account server 108, indicating that the rebate amount should be paid to the user associated with the registered e-mail address.

Account server 108 retrieves the account information associated with the e-mail address from user identifier table 134. Account server 108 checks the messaging table 136 associated with enterprise 106 to determine whether there is pre-defined message content that should be delivered to a user in response to certain triggering conditions. Messaging table 136 indicates that certain message content should be delivered to the user via the e-mail address once the payment transaction has been completed. Account server 108 communicates with the applicable financial institutions 110 to facilitate the transfer of funds from enterprise 106 to the user account. Account server 108 communicates suitable message content to the user confirming completion of the payment transfer as specified in messaging table 136. Account server 108 also sends a notification of completed transaction to enterprise 106.

In a variation on the exemplary embodiment of operation, if the user did not have the e-mail address registered with account server 108, the user may be sent a message requesting registration of the e-mail address. The message may be delivered to the user by enterprise 106, account server 108, and/or from any other suitable source. The message may be delivered through a website that appears on GUI 112 of device 112, via the provided e-mail address, and/or by any other suitable method. Once the user registers an account with account server 108, the process continues similar to that noted above. If the user registration fails for some reason, enterprise 106 provides the rebate payment through another mechanism such as a paper check.

A component of system 10 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, messaging table 136 may include different messages depending on the type of user identifier. Messaging table 136 may include one message for an e-mail address user identifier and another message for a mobile phone number user identifier. Furthermore, the components of system 10 may be integrated or separated. For example, a particular financial institution 110 may include a component similar to account server 108. As part of the process of settling payment through a user identifier, enterprise 106 may send a query directly to the particular financial institution 110. If the financial institution 110 has the user identifier registered and associated with one of its accounts, then a funds transfer may occur. If enterprise 106 also has an account administered by the financial institution, the funds transfer may happen very quickly, perhaps on the same day.

FIG. 2 illustrates an example method 200 for processing a payment to a user. The method begins at step 202, where pre-defined messages are communicated to an account server. The pre-defined message may be sent together with triggering conditions. The messages will be sent to the user automatically in response to the satisfaction of the triggering condition. At step 204, it is determined that a user should be paid. This determination may be receipt of an instruction of an administrator on an administrative computer, receipt of an instruction to process payment from a user via a website, determining that the time has come for a payment to a user according to a schedule, and/or any other suitable mechanism for determining that a user should be paid. At step 206, a particular user identifier is received. The user identifier may be an e-mail address, phone number, instant messaging user name, a social media identifier, and/or any other suitable identifier.

At step 208, the method determines whether the user identifier is registered. This may be a query and response communicated to the account server in real-time. As another example, a payment transactions server from the enterprise may store an indication of whether the user identifier is registered. Additionally, a payment transactions server may send the user identifier to a particular financial institution directly. If the user is not registered, a request is sent to the user to register the user identifier at step 210. If registration is attempted and the user identifier is still not registered with the account server (step 212), an alternative form of payment may be issued at step 214.

If the user is registered, a payment transfer is requested at step 216. At step 218, messages associated with payment transfers are received. For example, a message may be received indicating that the payment process has begun and/or that the payment process has been completed. At step 220, the user is sent a message associated with the payment request. This may be a status update mid-processing and/or a message that the payment transfer has been completed. Following step 220, the method may end.

Modifications, additions, or omissions may be made to method 200 disclosed herein without departing from the scope of the invention. The methods may include more, fewer, or other steps. For example, step 202 may be omitted such that pre-defined messages do not have to be sent to the account server. Alternatively, messages associated with the payment transfer may be sent along with or after the payment transfer request at 216. Additionally, steps may be performed in parallel or in any suitable order.

Certain embodiments of the invention may provide one or more technical advantages. A technical advantage of one embodiment allows an entity to provide a payment to a user without requiring the user to provide any private information, such as a financial account number. Another technical advantage of an embodiment allows an entity to issues an electronic payment to a user instead of providing a paper check in the amount of the payment. Another technical advantage of an embodiment allows an entity to keep track of all of its payment transfer requests through reporting of aggregate metrics. Notifications may be sent to the entity and/or the user providing status updates during the payment transfer process and when the transfer is completed. In particular embodiments, the notifications sent to the user may include message content pre-defined by the entity. The notifications may appear to be sent from the entity when they are actually sent from another source.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. A payment transaction server for processing a payment, comprising:
a memory comprising rules for processing a payment; and
a processor communicatively coupled to the memory and operable to:
determine that a user should receive the payment;
receive a user identifier associated with the user, wherein the user identifier does not comprise information regarding any financial account of the user;
determine whether the user identifier is registered with a separate account server operable to maintain associations between user identifiers and financial accounts;
request that the user determined to receive the payment register the user identifier with the account server if the user identifier is not registered with the account server; and
if the user identifier is registered with the account server, transfer the payment to a financial account accessed via the user identifier from the account server, and, if the user identifier is not registered with the account server, issue a paper cheek with the payment payable to the user.

2. The server of claim 1, wherein the processor is further operable to:
determine that the user identifier is registered with the account server;
communicate to the account server a request for transfer of the payment amount to the user; and
receive a notification from the account server associated with the transfer.

3. The server of claim 1, wherein the user identifier is one of a group comprising an e-mail address, a phone number, an instant messaging user name, and a social media identifier.

4. The server of claim 1, wherein the processor is further operable to communicate to the account server a message comprising the user identifier.

5. The server of claim 1, wherein the request for the transfer of the payment amount specifies a source account from which to deduct the payment amount and instructions as to when the payment amount should be transferred.

6. The server of claim 1, wherein the processor is further operable to request that the account server send a registration request to the user.

7. The server of claim 1, wherein the processor is further operable to communicate message content to the account server prior to determining that the user should receive the payment, wherein the account server is operable to communicate to the user a message that comprises at least a portion of the message content.

8. A method for processing a payment, comprising:
determining that a user should receive a payment;
receiving a user identifier associated with the user, wherein the user identifier does not comprise information regarding any financial account of the user;
determining, using a processor, whether the user identifier is registered with an account server operable to maintain associations between user identifiers and financial accounts;
requesting, using the processor, that the user determined to receive the payment register the user identifier with the account server if the user identifier is not registered with the account server; and
if the user identifier is registered with the account server, transferring the payment to a financial account accessed via the user identifier from the account server, and, if the user identifier is not registered with the account server, issuing a paper check with the payment payable to the user.

9. The method of claim 8, further comprising:
determining that the user identifier is registered with the account server;
communicating to the account server a request for transfer of the payment amount to the user; and
receiving a notification from the account server associated with the transfer.

10. The method of claim 8, wherein the user identifier is one of a group comprising an e-mail address, a phone number, an instant messaging user name, and a social media identifier.

11. The method of claim 8, wherein determining whether the user is registered with the account server comprises communicating to the account server a message comprising the user identifier.

12. The method of claim 8, wherein the request for the transfer of the payment amount specifies a source account from which to deduct the payment amount and instructions as to when the payment amount should be transferred.

13. The method of claim 8, wherein requesting that the user register the user identifier with the account server comprises requesting that the account server send a registration request to the user.

14. The method of claim 8, further comprising communicating message content to the account server prior to determining that the user should receive the payment, wherein the account server communicates to the user a message that comprises at least a portion of the message content.

15. A non-transitory computer readable medium comprising logic, the logic when executed by a processor, operable to:
determine that a user should receive a payment;
receive a user identifier associated with the user, wherein the user identifier does not comprise information regarding any financial account of the user;
determine whether the user identifier is registered with an account server operable to maintain associations between user identifers and financial accounts;
request that the user determined to receive the payment register the user identifier with the account server if the user identifier is not registered with the account server; and
if the user identifier is registered with the account server, transfer the payment to a financial account accessed via the user identifier from the account server, and, if the user identifier is not registered with the account server, issue a paper check with the payment payable to the user.

16. The computer readable medium of claim 15, wherein the logic is further operable to:
determine that the user identifier is registered with the account server;
communicate to the account server a request for transfer of the payment amount to the user; and
receive a notification from the account server associated with the transfer.

17. The computer readable medium of claim 15, wherein the user identifier is one of a group comprising an e-mail address, a phone number, an instant messaging user name, and a social media identifier.

18. The computer readable medium of claim 15, wherein the request for the transfer of the payment amount specifies a source account from which to deduct the payment amount and instructions as to when the payment amount should be transferred.

19. The computer readable medium of claim 15, wherein the logic is further operable to request that the account server send a registration request to the user.

20. The computer readable medium of claim 15, wherein the logic is further operable to communicate message content to the account server prior to determining that the user should receive the payment, wherein the account server is operable to communicate to the user a message that comprises at least a portion of the message content.
